(19) United States
(12) Patent Application Publication
(10) Pub. No.: US 2015/0122756 A1
(43) Pub. Date: May 7, 2015

(54) LOOM BRACELET HOLDER, DISPLAY AND TRANSPORT APPARATUS

(71) Applicant: Jake & Crew LLC, Livingston, NJ (US)

(72) Inventors: Katy STRULSON, Livingston, NJ (US); Lauren Scherr, Livingston, NJ (US)

(73) Assignee: Jake & Crew LLC, Livingston, NJ (US)

(21) Appl. No.: 14/074,004

(22) Filed: Nov. 7, 2013

(51) Int. Cl. A47F 7/02; A47G 29/08; F16B 9/02

(52) U.S. Cl. CPC A47F 7/022; F16B 9/02; A47G 29/08
USPC 211/85.2

(57) ABSTRACT

A loom bracelet holder and organizer is made up of two detachable elements a hollow rod and a base into which the rod is mounted. Once assembled the elements facilitate the transport and display of loom bracelets. The elements are easily detachable by merely pulling apart the rod and base from each other.

### BACKGROUND

Loom bracelet makers that convert conventional rubber bands into fashionable loom bracelets have become popular children toys. The loom bracelet makers which allow for endless patterns and designs limited only by the imagination of the children creating the bracelets are widely sold by toy and craft stores. Users of these toys in the course of a few hours can create a dozen or more different loom bracelets and take great pride in showing their handiwork to friends and family members.

Creation of a relatively large numbers of loom bracelets presents particular handling challenges to the children creating them. More particularly, it has been difficult for children to organize, display, access and transport their creations when showing them off to their friends and family members.

### SUMMARY

Applicant has created an apparatus which solves the above described handling problems, and facilitates the organization, display, access and transport of loom bracelets. An exemplary non-limiting example of the apparatus involves two detachable elements a cylindrical shaped hollow rod and a base to which the rod attaches. The loom bracelets are stacked around the rod and are held in place by gravity and the base disposed at one end of the rod.

The assembled elements allow the loom bracelets to be organized and easily displayed, and facilitate their transport as well. The detachability of the elements allows easy access to loom bracelets that are placed towards the bottom of the rod near where it is detachably connected to the base. During display, if access is desired to a loom bracelet disposed near the base of the assembled elements, then the rod can be easily detached from the base and the loom bracelet of interest can be removed from the detached end of the rod without removing the stacked loom bracelets from the other end of the rod.

The base can be virtually any shape but preferably can be circular, square or oblong and of sufficient size to provide stability to the assembled elements. More particularly the base attaches to one end of the rod so that when the base sits horizontally on a flat surface such as a table, the rod extends upwardly and perpendicularly from the base.

### BRIEF DESCRIPTION OF THE DRAWINGS

FIG. 1 shows a profile view of the assembled elements;

FIG. 2 shows a perspective view of the assembled elements; and

FIG. 3 shows a plan view of the base into which the rod fits.

### DETAILED DESCRIPTION

The detachable rod 10 and base 20 are preferably formed by plastic or resin material but, as will be understood by those skilled in the art, can be formed by other material as well. If formed of plastic the components lend themselves to be made by injection molding techniques or the like.

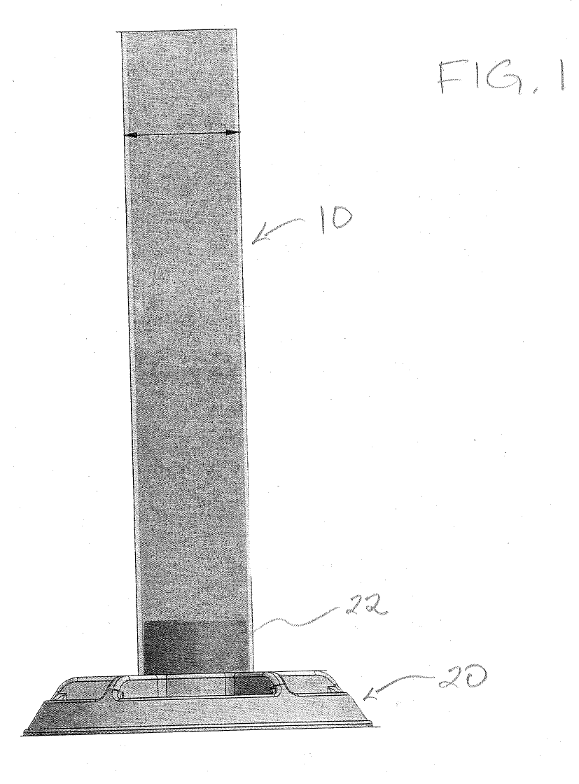

FIG. 1 shows rod 10 and base 20 joined together for use as a loom bracelet, organizer, display and transporter. The loom bracelets are stacked along rod 10, and access to loom bracelets disposed near base 20 can be easily accessed by detaching rod 10 from base 20.

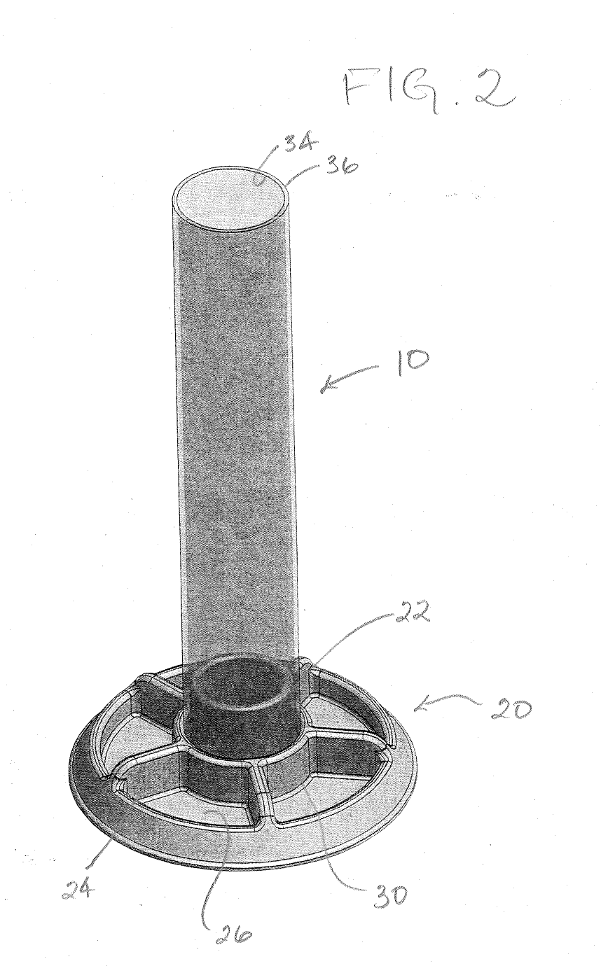

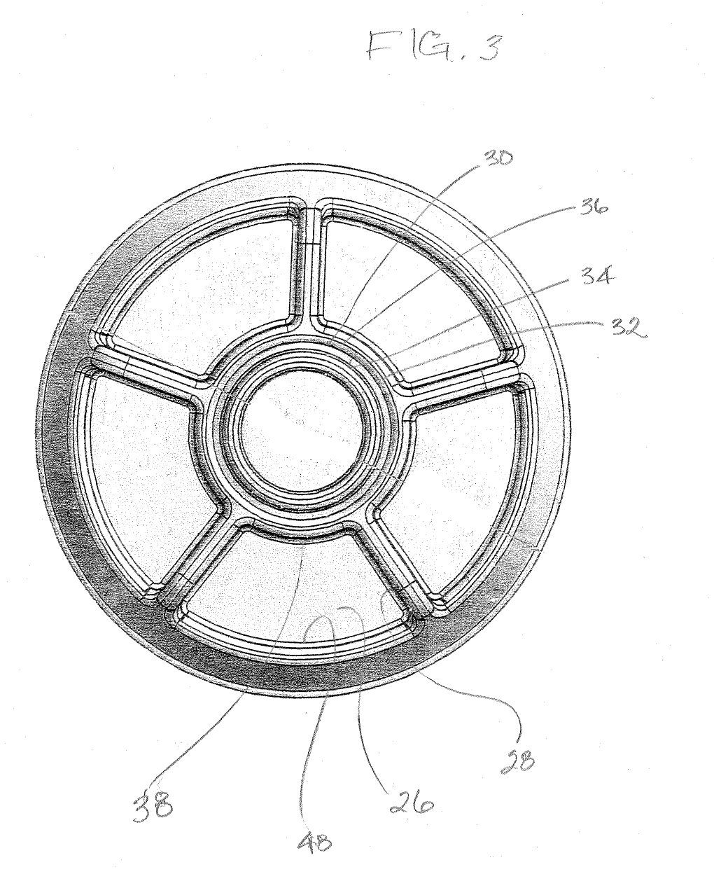

Rod 10 is firmly held within base 20 by forces applied between the inner circumference 34 of rod 10 and outer circumference 32 of base 20 and the outer circumference 36 of rod 10 and the inner circumference 30 of base 20, as shown in FIGS. 2 and 3. To provide stability a portion 22 of base 20 extends inwardly into the hollow portion of rod 20.

Alternatively, other means of firmly holding rod 10 within base 20 can be employed including, but not limited to, forming depressible ribs on the inner circumference 34 and/or outer circumference of rod 10 (not shown). In any event, the forces holding rod 10 firmly in base 20 can be easily overcome by applying one or more forces in an opposite direction from the joining direction of these components. For example, by simply grasping rod 10 with moderate hand pressure and pulling it away from base 20 the assembly can be detached.

FIG. 3 shows storage trays 26 disposed radially around base 20. Storage trays 26 are formed by raised walls 28, 38, and 48 in base 20, and provide additional storage locations for loom bracelets, loom rings, other materials, etc.

While the foregoing written description of the exemplary embodiments described herein enables one of ordinary skill in the art to make and use what is considered presently to be the preferred implementation or best mode, those of ordinary skill will understand and appreciate the existence of variations, combinations, and equivalents of the specific apparatuses, and examples described herein. The invention should therefore not be limited by the above described implementations, including apparatuses, and examples, but by all such implementations within the scope and spirit of the appended claims.

What is claimed:

1. A bracelet holder comprising:
a hollow rod shaped member; and
a disk shaped base member into which said rod shaped member is detachably mounted, said rod shaped member and base member being attached perpendicularly to each other so that if the base is placed on a horizontal surface the rod shaped member extends perpendicularly from the base and horizontal surface.

2. The bracelet holder of claim 1, wherein said hollow rod shaped member when mounted within said base member has its inner and outer circumferences at one end wedged between inner and outer circumferences of adjacent wall like appendages formed on said base member.

3. The bracelet holder of claim 1, wherein said base member further comprises open storage trays formed in an upper top surface of the base member.

4. The bracelet holder of claim 2, wherein said base member further comprises open storage trays formed in an upper top surface of the base member.

5. The bracelet holder of claim 1, wherein said rod shaped member and said base member are formed from plastic material.

6. The bracelet holder of claim 2, wherein said rod shaped member and said base member are formed from plastic material.

7. The bracelet holder of claim 3, wherein said rod shaped member and said base member are formed from plastic material.

8. The bracelet holder of claim 2, wherein friction forces between said rod shaped member and said base member maintain their assembly but the friction forces can be overcome by applying at least one force to at least one of said rod shaped member and said base member in a direction away from the other one of said rod shaped member and said base member.

9. The bracelet holder of claim 4, wherein friction forces between said rod shaped member and said base member maintain their assembly but the friction forces can be overcome by applying at least one force to at least one of said rod shaped member and said base member in a direction away from the other one of said rod shaped member and said base member.

10. The bracelet holder of claim 6, wherein friction forces between said rod shaped member and said base member maintain their assembly but the friction forces can be overcome by applying at least one force to at least one of said rod shaped member and said base member in a direction away from the other one of said rod shaped member and said base member.
